(19) United States
(12) Patent Application Publication
(10) Pub. No.: US 2004/0115358 A1
(43) Pub. Date: Jun. 17, 2004

(54) Coating method of plastic parts

(75) Inventors: Hiroshi Ishikawa, Tokyo (JP); Toshiki Takagi, Osaka (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/728,898

(22) Filed: Dec. 8, 2003

(30) Foreign Application Priority Data
Dec. 10, 2002 (JP) 2002-357882

(51) Int. Cl. B05D 1/36

(52) U.S. Cl. 427/407.1

(57) ABSTRACT

A coating method of a plastic parts comprises coating a primer paint on a work made of a black color family plastic, coating a color base paint containing a color pigment on a primer coating film formed by coating the primer paint, coating a base paint containing a effect pigment on a color base coating film formed by coating the color base paint, and coating a clear paint on a base coating film formed by coating the base paint. In the coating method, the primer paint contains a color pigment having L* value of 80 or more in CIE colorimetric system L*a*b*.

### BACKGROUND OF THE INVENTION

1. Field of the Invention

The present invention relates to a coating method of a plastic parts, and particularly, to a preferable coating method of a plastic parts employed to coat a top paint of white pearl colors on the plastic parts having a surface in a black color family.

2. Description of the Related Art

In a coating system having a work of providing a plastic parts, after a primer paint, a color base paint, a base paint containing a effect pigment and a clear paint are sequentially coated in a wet on wet manner, each of these coatings are baked at one time.

### SUMMARY OF THE INVENTION

However, there has been the following problem especially when coating a low hiding power paint such as a white pearl coating color due to show a black color surface of the coated plastic parts itself because of a design requirement thereof.

First of all, a film thickness of a color base coating film is required to be equal to or more than 18 μm for the purpose of hiding the surface of the plastic parts. When the film thickness of the color base coating film becomes less than 18 μm, the hue of a top coat film varies to a blackness direction and a yellowness shortage direction due to the insufficient hiding power, which results in a poor color difference. Therefore, it is necessary to keep the film thickness of the color base coating in order to prevent the poor color difference, however, this causes a higher cost because of an increase in coating man-hours and a material expense of coating.

In addition, an idea of increasing the concentration of a white color family pigment in the coating is raised as a method to reduce the film thickness of the color base coating film to less than 18 μm. However, the concentration of the white color family pigment in the color base paint cannot be increased any further because a property of a coating film such as weather resistance and adhesiveness of base paint containing a effect pigment is deteriorated.

Furthermore, a lot of coating man-hours are required to keep the film thickness of the color base coating film equal to or more than 18 μm. As for a method to keep the film thickness of the color base coating film even while reducing the coating man-hours, increasing the viscosity of the color base paint has been considered. However, this method deteriorates the coating surface and the distinctness of the image of the color base coating film, which leads to a deteriorated coating surface and in distinctness of the image of the top coat film.

The present invention was made in consideration of the above-described problems. It is an object of the present invention to provide a coating method which can ensure opacity against the black color plastic parts even though the film thickness of the color base coating film is reduced without an increase in both the pigment concentration and the viscosity of color base paint.

The first aspect of the present invention provides a coating method of a plastic parts, comprising: coating a primer paint on a work made of a black color family resin; coating a color base paint containing a color pigment on a primer coating film formed by coating the primer paint; coating a base paint containing a effect pigment on a color base coating film formed by coating the color base paint; and coating a clear paint on a base coating film formed by coating the base paint, wherein the primer paint contains a color pigment having an L* value of 80 or more in CIE calorimetric system L*a*b*.

The second aspect of the present invention provides a coating method of a plastic parts, comprising: coating a primer paint containing organic color pigments and/or inorganic color pigments on a work made of a black color family resin; coating a color base paint containing color pigments on a primer coating film formed by coating the primer paint; coating a base paint containing a effect pigment on a color base coating film formed by coating the color base paint; and coating a clear paint on a base coating film formed by coating the base paint, wherein a tone of a coating film formed by coating the primer paint, the color base paint, the base paint and the clear paint has an L* value of 80 or more in CIE calorimetric system L*a*b* and a value of 10 or less in a formula of √{(a*)²+(b*)²}.

### BRIEF DESCRIPTION OF THE DRAWINGS

The invention will now be described with reference to the accompanying drawings wherein;

FIG. 1 shows the processes where an embodiment of a coating method of the present invention is illustrated and the sectional views of coating films in each process;

FIG. 2 shows the processes where another embodiment of the coating method of the present invention is illustrated and the sectional views of coating films in each process;

FIG. 3 shows the processes where another embodiment of the coating method of the present invention is illustrated and the sectional views of coating films in each process;

FIG. 4 is a graph showing the relationship between film thicknesses of primer coating film and color base coating film according to the present invention;

FIGS. 5A to 5C are graphs showing the results of the Examples 1 to 3 of the present invention;

FIGS. 6A to 6C are graphs showing the results of the Examples 4 to 6 of the present invention; and

FIG. 7 is a table showing the results of both Examples and Comparative Examples.

### DETAILED DESCRIPTION OF THE PREFERRED EMBODIMENT

Hereinafter, description will be made of embodiments of the present invention with reference to the drawings.

Works of the present embodiments are plastic parts such as a bumper and others having a black color surface. The works of the present invention are not limited to the particular components and materials but those used as, for example, automobile components are suitably employed regardless of the material. Particularly, an effect of the present invention becomes more significant when it is applied to plastic parts having a black color surface.

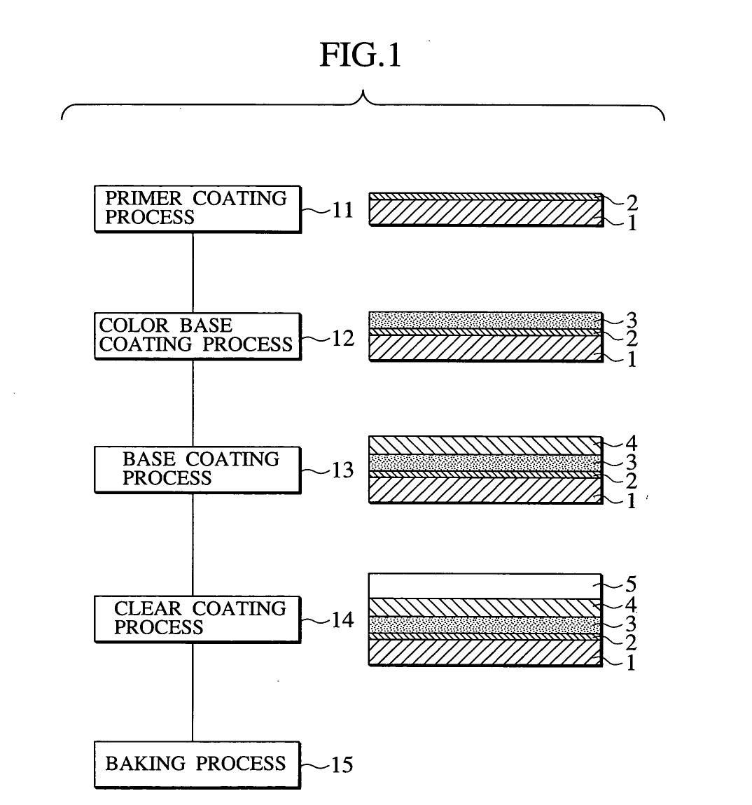

In a coating method of the present embodiments, as shown in FIG. 1, a primer coating film 2 is formed at first by coating a primer paint on the surface of plastic parts 1 in the primer coating process 11. This primer paint is one to secure adhesiveness between the plastic parts 1 and top coat films 4 and 5 (actually, color base coating film 3). In addition, the primer paint also provides a function of opacity because the plastic parts 1 shows the black color surface in the present embodiments.

Namely, a color pigment is not generally added to the primer paint, however, in the present embodiment, the color pigment having an L* value of 80 or more in CIE calorimetric system L*a*b* (CIE LAB color space) is added to the primer paint so that a value of lightness of primer coating film 2 becomes high. CIE LAB color space is based on JIS Z8729.

A yellow color pigment may be shown as those having an L* value of 80 or more because the value of lightness of yellow color hue is the highest in chromaticity a* and b*. The examples thereof are organic color pigments such as quinophthalone family yellow pigments, isoindoline family yellow pigments and isoindolinone family yellow pigments. These pigments may be used alone or in any combination of their mixtures. Furthermore, since the color pigment added to the primer paint is acceptable in the present invention as long as the L* value thereof is 80 or more, it is not limited to the yellow color pigment. In addition, besides the organic one, an inorganic color pigment may be used.

The color pigment having an L* value of 80 or more used in the present embodiment is preferably added to the primer paint by an amount equal to or more than 0.03 wt % and by an amount equal to or less than 1 wt % to the solid content of the primer paint. If the content of the color pigment is less than 0.03 wt %, the opacity aimed by the present invention becomes insufficient for the surface of the plastic parts. Furthermore, if the content of the color pigment exceeds 1 wt %, ill effects are incurred to the adhesiveness and the weather resistance of the primer coating film.

The preferable film thickness of the primer coating film 2 of the present embodiment is equal to or more than 5 μm and equal to or less than 15 μm. If the film thickness of the primer coating film 2 is less than 5 μm, the adhesiveness which the primer coating film essentially has between the top coat film and the plastic parts becomes insufficient, and the opacity for the surface of the plastic parts becomes inadequate. In addition, if the film thickness of primer coating film 2 exceeds 15 μm, the cost is increased due to overquality.

Next, after finishing the primer coating process 11, in a color base coating process 12 as shown in FIG. 1, a color base coating film 3 is formed by coating of the color base paint in a wet on wet manner following the previously coated primer coating film 2. Since the color base paint is used to hide the surface of plastic parts 1, it contains a color pigment giving the same tone as that of the top coat paint when the top coat exhibits a white color family. The top coat paint in the present embodiment is a white pearl color paint, therefore, the color base paint contains a white color family pigment. However, in the coating method of the present embodiment, the opacity of the color base paint is not required to be so high since the primer coating film 2 has opacity. For example, a color base paint which has a hiding power of 30 μm or more is used in the present embodiment. Thus, the color base paint is excellent in terms of weather resistance and adhesiveness because the content of the color pigment in the color base paint can be reduced. Herein, hiding power means the smallest film thickness whereby the color of a surface cannot be visually recognized and, specifically, the smallest film thickness wherein it becomes impossible to distinguish the color of black and white by the naked eye checking the color through the coating film coated on a black and white board.

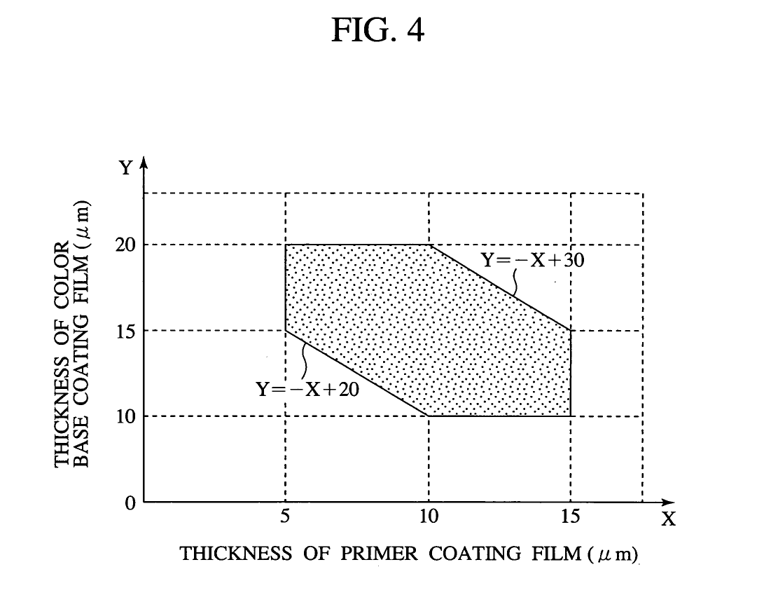

The thickness of the color base coating film 3 of the present embodiment is preferably provided as shown in FIG. 4 in consideration of the relation with the thickness of the primer coating film 2. FIG. 4 is a graph showing the relationship between both film thicknesses of the primer coating film 2 and color base coating film 3 according to the present embodiment, and the hatching part in FIG. 4 shows a suitable thickness range.

In other words, as described above, the suitable range of the film thickness X (μm) of the primer coating film 2 is equal to or more than 5 μm and equal to or less than 15 μm, and, on the other hand, the film thickness Y (μm) of the color base coating film 3 is preferably in a condition that when the film thickness X (μm) of the primer coating film 2 is 5 μm≦X≦10 μm, Y is −X+20 ≦Y≦20, and when X is 10 μm≦X≦15 μm, Y is 10 ≦Y≦−X+30.

Thereby, since the film thickness of the color base coating film 3 can be set thinner than that of a conventional film, the coating man-hours of the color base coating process 12 and the material cost of the color base paint can be reduced. In addition, since opacity can be secured without increasing the viscosity of the color base paint, the coating surface and the distinctness of the image of the color base coating film 3 is enhanced, which also improves the coating surface and the distinctness of image of the top coat films 4 and 5.

Next, after finishing the color base coating process 12, in a base coating process 13 as shown in FIG. 1, a base coating film 4 containing a effect pigment is formed by coating of the base paint which contains a effect pigment in a wet on wet manner following the previously coated color base coating film 3. The base coating film 4 containing a effect pigment forms the top coat film together with the clear coating film 5 coated in the next process, and gives the coating color of the plastic parts. The effect pigments such as aluminum flake and mica flake can be used, which gives a glitter to the coating film in view of design. Generally, since the white pearl color base paint containing a effect pigment shows an extremely low opacity to the substrate, the color base coating film 3 is given the opacity to the substrate as described above. The film thickness of the base coating film 4 containing a effect pigment is preferably equal to or more than 8 μm and equal to or less than 15 μm.

Then, after finishing the base coating process 13, in a clear coating process 14 as shown in FIG. 1, a clear coating film 5 is formed by coating of the clear paint in a wet on wet manner following the previously coated base coating film 4 containing a effect pigment. The clear coating film 5 forms the top coat film together with the base coating film 4 containing a effect pigment as described above, and is a transparent coating film which does not contain a color pigment. The film thickness of clear coating film 5 is preferably equal to or more than 20 μm and equal to or less than 40 μm.

Particularly, the tone of the top coat film in the present embodiment which comprises the base coating film 4 containing a effect pigment and the clear coating film 5 shows a white pearl coating color having the L* value of 80 or more in CIE colorimetric system L*a*b* and the value of 10 or less in a formula of √{(a*)²+(b*)²}.

According to the forgoing processes, after forming the primer coating film 2, the color base coating film 3, the base coating film 4 containing a effect pigment and the clear coating film 5, these four coating films are baked in a baking process 15 at one time. The baking condition is 130° C.×20 minutes, for example.

Even though the plastic parts 1 has a black color surface, the top coat films 4 and 5 formed by the forgoing process can hide the black surface with the primer coating film 2 and the color base coating film 3, which results in a significantly small color difference compared with the standard tone of the targeted top coat film.

In addition, since the film thickness of the color base coating film 3 can be decreased compared with the conventional one (for example, 18 μm), the coating man-hours in the color base coating process 12 and the material cost of color base paint are also reduced.

Moreover, since the opacity of the top coat films 4 and 5 can be secured in cooperation with the primer coating film 2 without increasing the opacity of color base paint, the content of color pigment in the color base paint can be reduced, and the weather resistance and the adhesiveness of the color base coating film 3 can be enhanced.

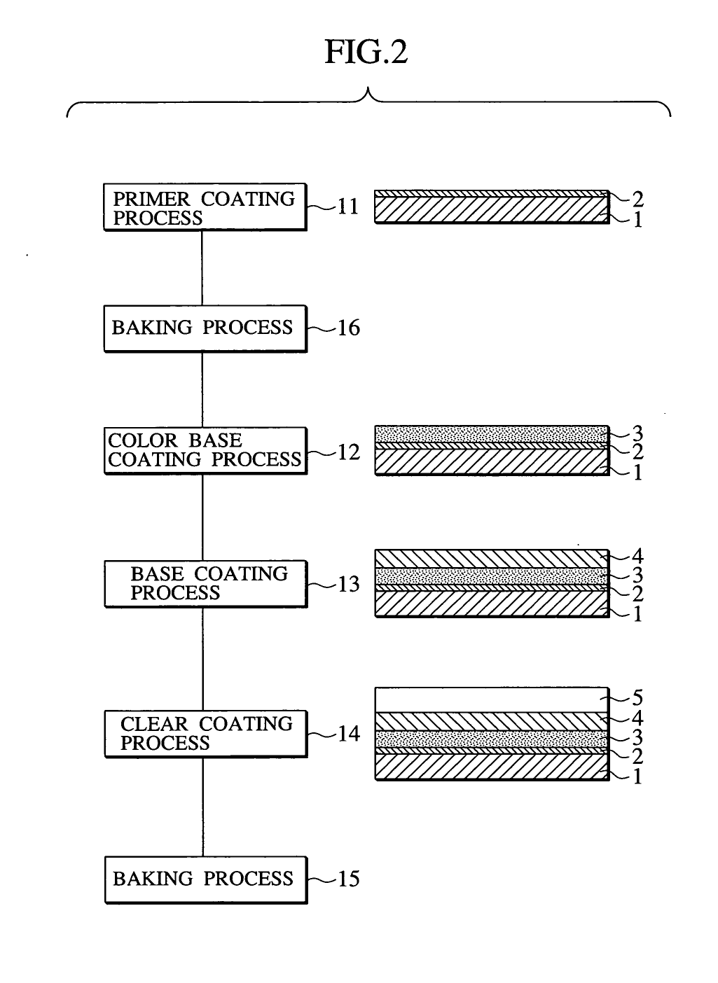

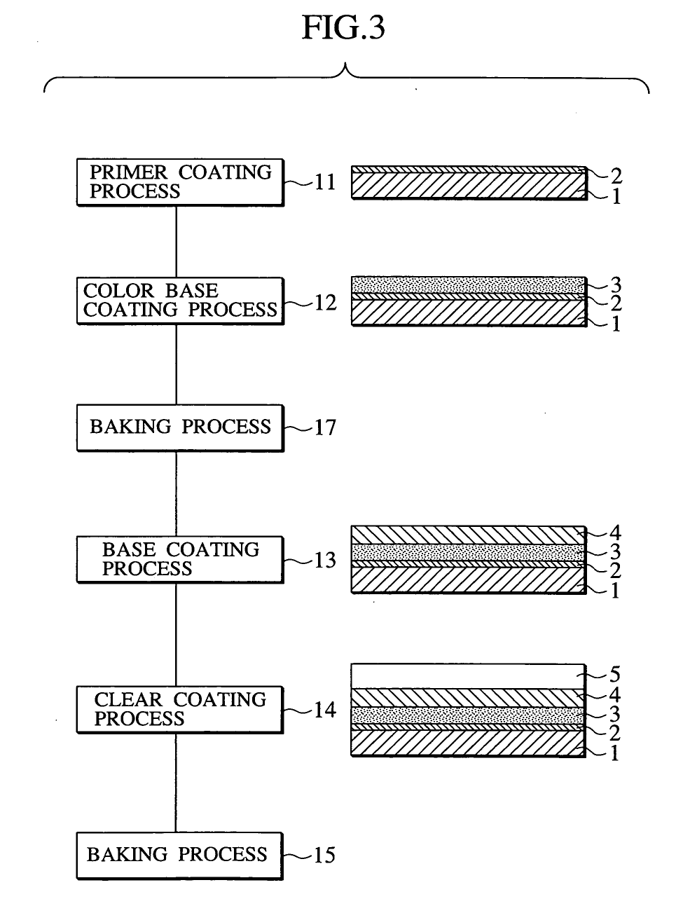

In the aforementioned embodiment, the primer coating film 2, the color base coating film 3, the base coating film 4 containing a effect pigment and the clear coating film 5 are baked together at one time (a so-called 4-coat-1-bake coating system). However, the coating method of the present invention also includes the coating system shown in FIG. 2 or FIG. 3.

As shown in FIG. 2, this embodiment is conducted by coating the same primer paint as that of aforementioned embodiment in the primer coating process 11, and then baking the same primer paint in the baking process 16. Thereafter, in the color base coating process 12, the color base coating film 3 is formed by coating a color base paint on the dried primer coating film 2. The following base coating process 13 and clear coating process 14 have the same process as that described in the foregoing embodiment. In the last baking process 15, the color base coating film 3, the base coating film 4 containing a effect pigment and the clear coating film 5 coated in a wet on wet manner are baked together at one time (a so-called 4-coat-2-bake coating system).

Additionally, as shown in FIG. 3, this embodiment is conducted by coating the same primer paint as that of aforementioned embodiment in the primer coating process 11, and coating a color base paint in a wet on wet manner in the color base coating process 12, and then baking the primer paint and the color base paint together in the baking process 17 at one time. Next, in the base coating process 13, the base coating film 4 containing a effect pigment is formed by coating a base paint containing a effect pigment on the dried color base coating film 3. Thereafter, the clear paint is coated in a wet on wet manner in the clear coating process 14, and in the last baking process 15, this base coating film 4 containing a effect pigment which is coated in a wet on wet manner and the clear coating film 5 are baked together at one time (a so-called 4-coat-2-bake coating system).

Thus, similarly to the 4-coat-1-bake coating system shown in FIG. 1, the 4-coat-2-bake coating system can also hide the black surface with the primer coating film 2 and the color base coating film 3 even though the plastic parts 1 has a black color surface, which results in a significantly small color difference as compared with the standard tone of the targeted top coat film.

In addition, since the film thickness of the color base coating film 3 can be decreased compared with the conventional one (for example, 18 μm), the coating man-hours in the color base coating process 12 and the material cost of color base paint are also reduced.

Moreover, since the opacity of the top coat films 4 and 5 can be secured in cooperation with the primer coating film 2 without increasing the opacity of color base paint, the content of the color pigment in the color base paint can be reduced, and the weather resistance and the adhesiveness of the color base coating film 3 can be enhanced.

Hereinafter, the coating method of the present invention is more specifically explained.

### EXAMPLE 1

Five test pieces made of polypropylene having a size of 140 mm×70 mm×3 mm thickness were prepared, and a primer paint was coated on these sheets at a 10 μm thickness. This primer paint was made by adding 0.2 wt % (ratio to the solid content of the primer paint) of quinophthalone family yellow pigment (Paliotol Yellow L-0960HD, L* value=85, made by BASF Corp.) to a primer paint (RB-194 N8.5 primer, made by Nippon Bee Chemical Co., Ltd.). Next, a color base paint (R-305DQX1 color base, Hiding power; 30 μm or more, made by Nippon Bee Chemical Co., Ltd.) was coated on each of five test pieces in a wet on wet manner while adjusting the thickness by 5 μm for each piece in the range of 5 μm to 25 μm. Further, a base paint containing a effect pigment (R-305DQX1 mica base, made by Nippon Bee Chemical Co., Ltd.) was coated thereon in a wet on wet manner at a 10 μm thickness. Furthermore, a clear paint (R-365 clear, made by Nippon Bee Chemical Co., Ltd.) was coated thereon in a wet on wet manner at a 25 μm thickness, then these coatings were baked together at one time under the condition of 130° C.×20 minutes.

The tone of obtained top coat film exhibited the L* value of 85 in CIE colorimetric system L*a*b* and the value of 5 in a formula of √{(a*)²+(b*)²}.

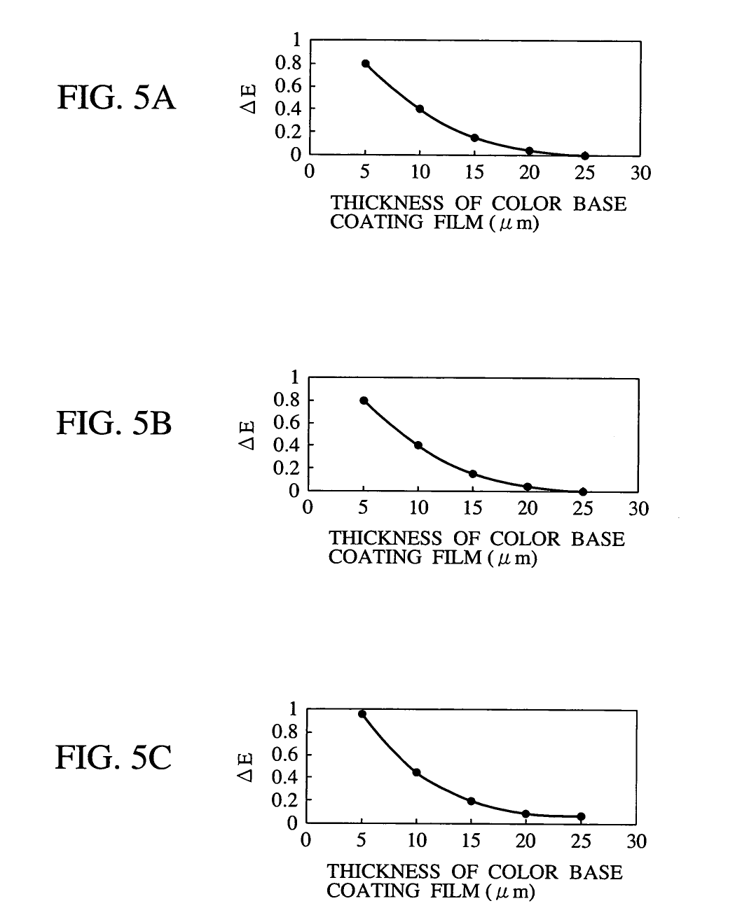

In addition, the color difference ΔE between the obtained top coat film and a color standard panel was measured. The result is shown in FIG. 5A.

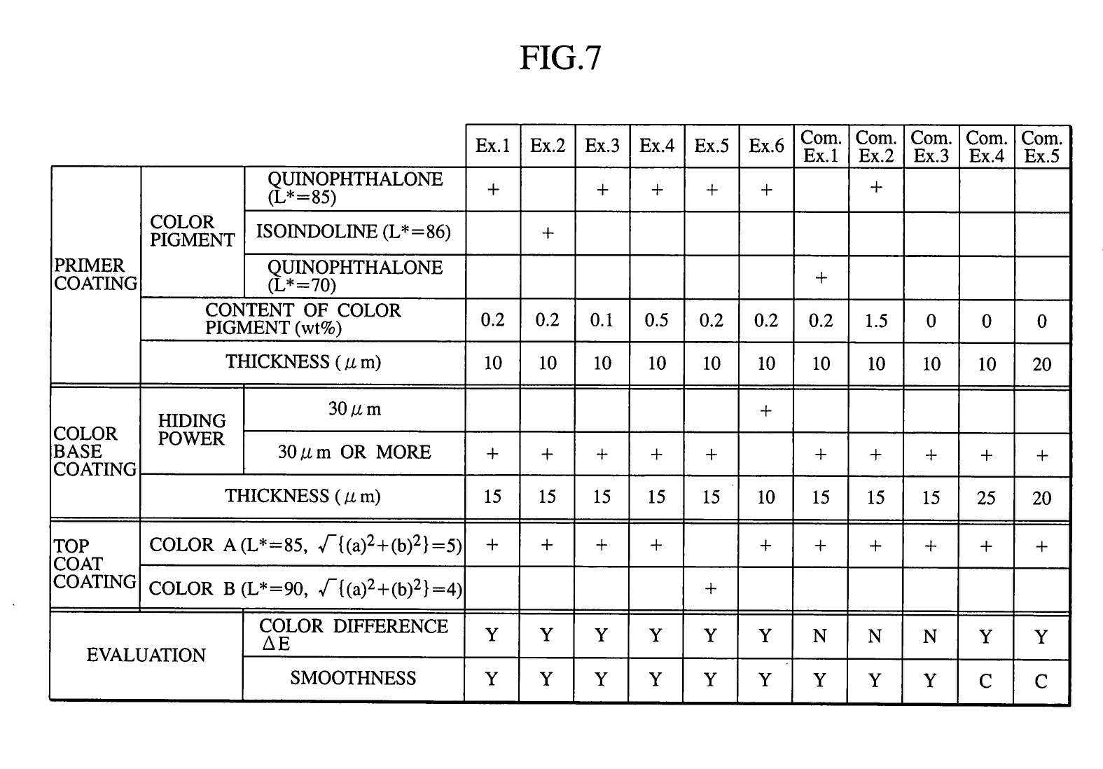

Moreover, the color difference ΔE was measured for the test piece having 15 μm thickness of the color base coating film among the obtained top coat films, and then the finish appearance (smoothness) was evaluated by the naked eye. The result is shown in FIG. 7 wherein the color difference ΔE of 0.5 or less is defined as Y and that exceeding 0.5 as N, and good smoothness is defined as Y and poor smoothness as C.

### EXAMPLE 2

The same condition as Example 1 was employed with the exception that the color pigment was changed to isoindoline family yellow pigment (IRGACOLOR Yellow 2GLMA, L* value=86, made by Ciba Geigy Corp.) added to the primer paint (RB-194 N8.5 primer, made by Nippon Bee Chemical Co., Ltd.). The color difference and the finish appearance were evaluated. The result is shown in FIG. 5B and FIG. 7.

### EXAMPLE 3

The same condition as Example 1 was employed with the exception that the addition amount (content) of the color pigment was set to 0.1 wt %, which was added to the primer paint (RB-194 N8.5 primer, made by Nippon Bee Chemical Co., Ltd.). The color difference and the finish appearance were evaluated. The result is shown in FIG. 5C and FIG. 7.

### EXAMPLE 4

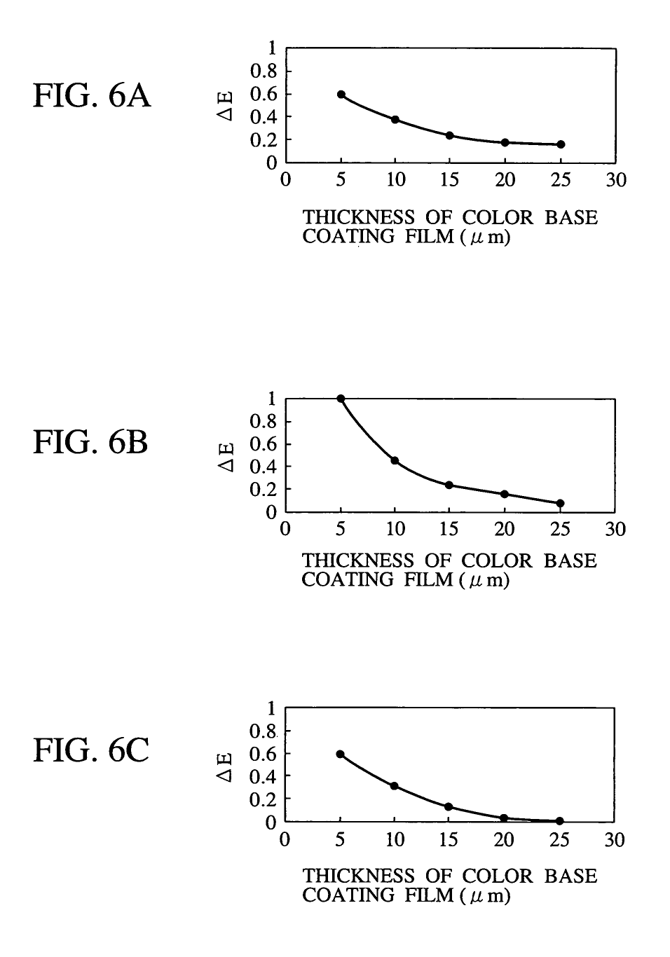

The same condition as Example 1 was employed with the exception that the addition amount (content) of the color pigment was set to 0.5 wt %, which was added to the primer paint (RB-194 N8.5 primer, made by Nippon Bee Chemical Co., Ltd.). The color difference and the finish appearance were evaluated. The result is shown in FIG. 6A and FIG. 7.

### EXAMPLE 5

The same condition as Example 1 was employed with the exception that the base paint containing a effect pigment was changed to another base paint (R-305D WKO mica base, made by Nippon Bee Chemical Co., Ltd.), and the tone of obtained top coat film exhibited the L* value of 85 in CIE calorimetric system L*a*b* and the value of 5 in a formula of √{(a*)²+(b*)²}. The color difference and the finish appearance were evaluated. The result is shown in FIG. 6B and FIG. 7.

### EXAMPLE 6

The same condition as Example 1 was employed with the exception that the color base paint was changed to one having 30 μm of hiding power and a film thickness of 10 μm. The color difference and the finish appearance were evaluated. The result is shown in FIG. 6C and FIG. 7.

### Comparative Example 1

The same condition as Example 1 was employed with the exception that the color pigment was changed to quinophthalone family yellow pigment (Paliotol Yellow L-2140HD, L* value=70, made by BASF Corp.) added to the primer paint (RB-194 N8.5 primer, made by Nippon Bee Chemical Co., Ltd.). The color difference and the finish appearance were evaluated. The result is shown in FIG. 7.

### Comparative Example 2

The same condition as Example 1 was employed with the exception that the addition amount (content) of the color pigment was set to 1.5 wt % which was added to the primer paint (RB-194 N8.5 primer, made by Nippon Bee Chemical Co., Ltd.). The color difference and the finish appearance were evaluated. The result is shown FIG. 7.

### Comparative Example 3

The same condition as Example 1 was employed with the exception that no color pigment was added to the primer paint (RB-194 N8.5 primer, made by Nippon Bee Chemical Co., Ltd.). The color difference and the finish appearance were evaluated. The result is shown in FIG. 7.

### Comparative Example 4

The same condition as Comparative Example 3 was employed with the exception that the film thickness of color base coating film was set to 25 μm. The color difference and the finish appearance were evaluated. The result is shown in FIG. 7.

### Comparative Example 5

The same condition as Comparative Example 3 was employed with the exception that the film thickness of primer coating film was set to 20 μm and that of color base coating film was set to 20 μm. The color difference and the finish appearance were evaluated. The result is shown in FIG. 7.

Examples and Comparative Examples are examined. None of Examples 1 to 6 showed a problem in color difference or smoothness. On the other hand, when using a primer paint without a color pigment in Comparative Examples 3 to 5, the color difference was large in Comparative Example 3 having 15 μm film thickness of color base coating film, and a problem was confirmed as occurring regarding to the smoothness in Comparative Examples 4 and 5 having 20 to 25 μm film thickness of color base coating film.

In addition, a primer paint which had a color pigment of low lightness (L* value=70) showed a problem in color difference (Comparative Examples 1 and 2), and a primer paint which had a high content of color pigment also gave a problem in color difference (Comparative Example 2).

The entire content of a Japanese Patent Application No. P2002-357882 with a filing date of Dec. 10, 2002 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A coating method of a plastic parts, comprising:
coating a primer paint on a work made of a black color family plastic;
coating a color base paint containing a color pigment on a primer coating film formed by coating the primer paint;
coating a base paint containing a effect pigment on a color base coating film formed by coating the color base paint; and
coating a clear paint on a base coating film formed by coating the base paint,
wherein the primer paint contains a color pigment having an L* value of 80 or more in CIE colorimetric system L*a*b*.

2. The coating method of the plastic parts according to claim 1,
wherein the color pigment of the primer paint is contained from an amount equal to or more than 0.03 wt % to an amount equal to or less than 1 wt % relative to a solid content of the primer paint.

3. The coating method of the plastic parts according to claim 1,
wherein a hiding power of the color base coating film is 30 μm or more.

4. The coating method of the plastic parts according to claim 1,
wherein a film thickness X (μm) of the primer coating film is 5 μm≦X≦15 μm, and
a film thickness Y (μm) of the color base coating film is −X+20≦Y≦20 when the film thickness X (μm) of the primer coating film is 5 μm≦X≦10 μm, and 10≦Y≦−X+30 when the film thickness X (μm) of the primer coating film is 10 μm≦X≦15 μm.

5. The coating method of the plastic parts according to claim 1,
wherein the color pigment contained in the primer paint includes at least one of organic color pigments among quinophthalone family yellow pigments, isoindoline family yellow pigments and isoindolinone family yellow pigments.

6. The coating method of the plastic parts according to claim 1,
wherein the primer paint, the color base paint, the base paint and the clear paint are baked after coating in a wet on wet manner.

7. The coating method of the plastic parts according to claim 1,
wherein the primer paint is baked after coating, and then the color base paint, the base paint and the clear paint are baked after coating in a wet on wet manner.

8. The coating method of the plastic parts according to claim 1,
wherein the primer paint and the color base paint are baked after coating in a wet on wet manner, and then the base paint and the clear paint are baked after coating in a wet on wet manner.

9. A coating method of a plastic parts, comprising:
coating a primer paint containing organic color pigments and/or inorganic color pigments on a work made of a black color family plastic;
coating a color base paint containing color pigments on a primer coating film formed by coating the primer paint;
coating a base paint containing a effect pigment on a color base coating film formed by coating the color base paint; and
coating a clear paint on a base coating film formed by coating the base paint,
wherein a tone of a coating film formed by coating the primer paint, the color base paint, the base paint and the clear paint has an L* value of 80 or more in CIE colorimetric system L*a*b* and a value of 10 or less in a formula of √{(a*)²+(b*)²}.
